(19) United States
(12) Patent Application Publication
(10) Pub. No.: US 2012/0272097 A1
(43) Pub. Date: Oct. 25, 2012

(54) TESTING DEVICE FOR REDUNDANT ARRAY OF INDEPENDENT DISKS

(75) Inventors: GUAN WANG, Shenzhen City (CN); GUO-FENG ZHANG, Shenzhen City (CN); ZHENG-QUAN PENG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/172,847

(22) Filed: Jun. 30, 2011

(30) Foreign Application Priority Data
Apr. 25, 2011 (CN) 201110103698.6

(51) Int. Cl. G06F 11/20

(52) U.S. Cl. 714/6.22; 714/E11.084

(57) ABSTRACT

An exemplary testing device includes a RAID unit including under test disk drives, a replacing unit including a reserve disk drive, a switching unit, a state recognition unit and a control unit. The switching unit includes buttons corresponding to the under test disk drives, respectively. Each of the buttons is switched between a first position in which a corresponding under test disk drive is in connection with the RAID unit and a second position in which the corresponding under test disk drive is disconnected from the RAID unit. The state recognition unit outputs status signals corresponding to the under test disk drives, respectively. The control unit receives the status signals from the state recognition unit and controls the reserve disk drive to successfully begin to work in replacement of the disconnected under test disk drive for rebuilding the RAID unit. The display unit displays a testing result thereon.

### BACKGROUND

1. Technical Field

The disclosure relates to testing devices, and particularly to an automatic testing device for a Redundant Array of Independent Disks (RAID).

2. Description of the Related Art

RAID, an acronym for Redundant Array of Independent Disks, is a technology that provides increased storage functions and reliability through redundancy. This is achieved by combining multiple disk drives into a logical unit, and having data distributed across the disk drives in one of several ways called “RAID levels.”

RAID is now used as an umbrella term for computer data storage schemes that can divide and replicate data among multiple disk drives. The disk drives are said to be in a RAID array, which is addressed by the associated operating system as one single disk. The different schemes or architectures are named by the word RAID followed by a number (e.g., RAID0, RAID1). Each scheme provides a different balance between two key goals: increase data reliability, and increase input/output performance.

During a reliability test of the RAID, one of the disk drives in the RAID is manually removed, to see if a change of an indicator light of the RAID is normal or abnormal. Then, a new disk drive is manually inserted into the RAID, to see if the RAID can rebuild the lost data and if a change of the indicator light is normal or abnormal. However, this testing method is rather laborious and inconvenient, and does not meet the current demand for highly automated testing of a RAID.

What is desired, therefore, is a testing device which can overcome the above-described shortcomings.

### BRIEF DESCRIPTION OF THE DRAWINGS

FIG. 1 is a block diagram of a testing device according to an exemplary embodiment of the present disclosure.

FIG. 2 is a schematic, front view of the testing device of FIG. 1.

FIG. 3 is a schematic, back view of the testing device of FIG. 1.

### DETAILED DESCRIPTION

Reference will now be made to the figures to describe various embodiments of the present testing device in detail.

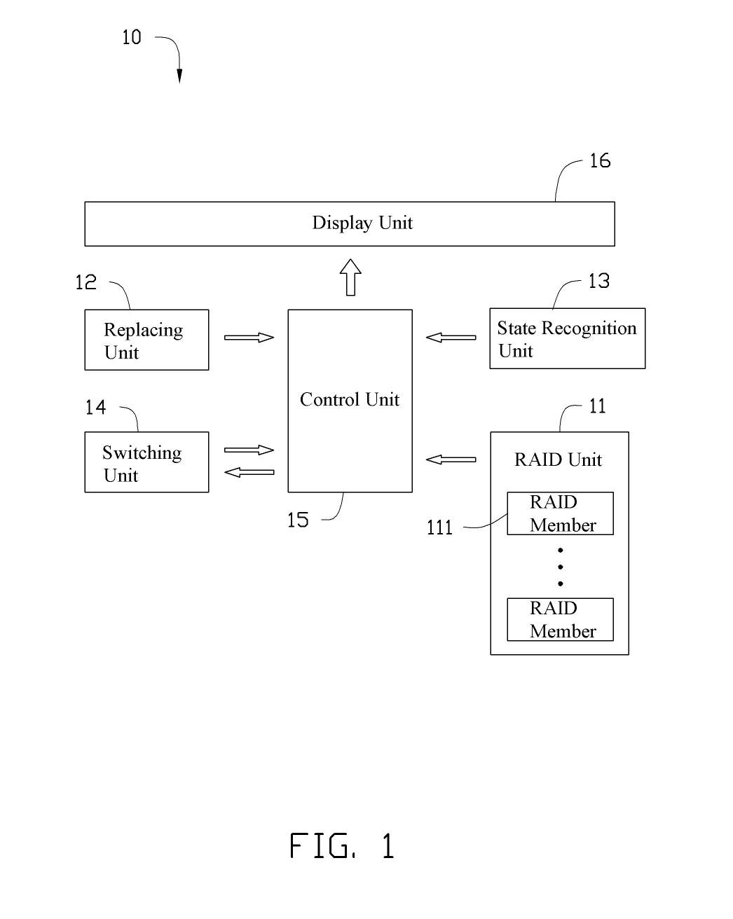

Referring to FIG. 1, a testing device 10 for testing a RAID unit 11 in accordance with an exemplary embodiment includes a replacing unit 12, a state recognition unit 13, a switching unit 14, a control unit 15 and a display unit 16.

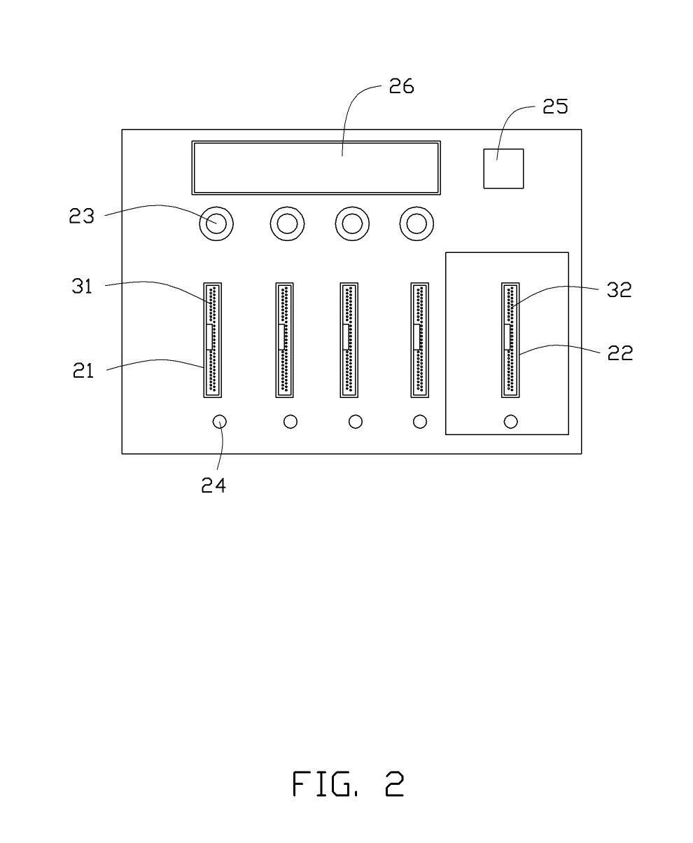

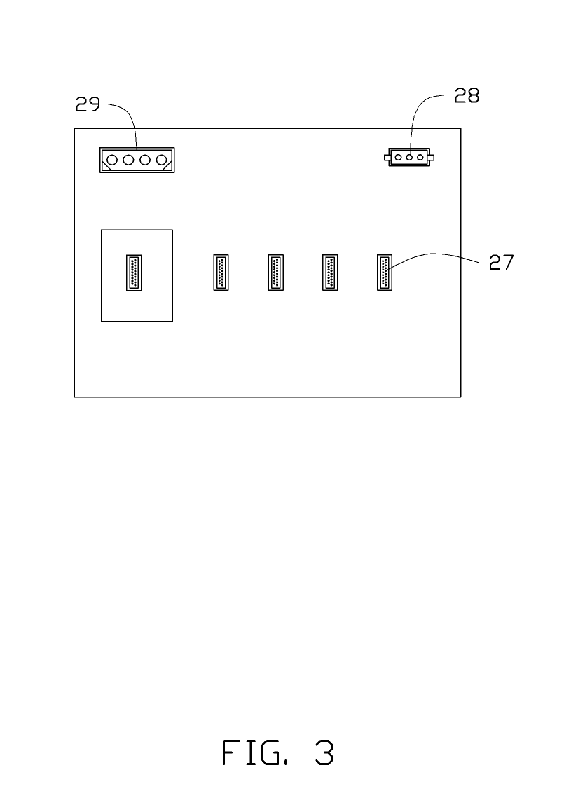

The RAID unit 11 includes a plurality of RAID members 111 arranged parallel to each other in a line. The RAID unit 11 can be RAID0, RAID1 or RAID5. Referring also to FIGS. 2 and 3, in this embodiment, there are four RAID members 111, which are arranged side by side along a widthwise direction of the testing device 10. Each of the RAID members 111 includes a main slot 21 at a front surface of the testing device 10, an under test disk drive 31 received in the main slot 21, and a data interface 27 aligned with the main slot 21 at a back surface of the testing device 10. The data interfaces 27 are electrically connected to a main circuit board (not shown) inside the testing device 10 via a plurality of electric wires (not shown), respectively. The under test disk drives 31 are electrically connected to the main board via the data interfaces 27, respectively, and are addressed by an associated operating system as one single disk to cooperatively build the RAID unit 11.

The replacing unit 12 includes a reserve slot 22 at the front surface of the testing device 10, a reserve disk drive 32 received in the reserve slot 22, and a data interface 27 aligned with the reserve slot 22 at the back surface of the testing device 10. The reserve slot 22 is located adjacent to the RAID unit 11. The reserve disk drive 32 is used as a replacement of one of the under test disk drives 31 of the RAID unit 11, under control of the control unit 15 during a reliability test of the RAID unit 11. In alternative embodiments, there can be two or more reserve slots 22 and two or more reserve disk drives 32, according to different requirements.

The state recognition unit 13 includes a detecting circuit received in an interior of the testing device 10, and a plurality of indicator lights 24 adjacent to the main slots 21 and the reserve slot 22, respectively. The indicator lights 24 correspond to the under test disk drives 31 and the reserve disk drive 32, respectively. The state recognition unit 13 can detect current working states of the under test disk drives 31 and the reserve disk drive 32, respectively, and output a plurality of first status signals corresponding to the current working states of the under test disk drives 31 and a second status signal corresponding to the current working state of the reserve disk drive 32 to the control unit 15.

Simultaneously, the state recognition unit 13 outputs in real time first and second status signals to a driving circuit (not shown) of the indicator lights 24, for separately controlling the indicator lights 24 to emit light with different colors. The different colors show different current working states of the under test disk drives 31 and the reserve disk drive 32.

The switching unit 14 includes a plurality of control buttons 23 corresponding to the under test disk drives 31, respectively, and a power button 25 for controlling an on/off status of the testing device 10. Each of the control buttons 23 can be pressed to switch between a first position in which a corresponding under test disk drive 31 is in connection with the main board, and a second position in which the corresponding under test disk drive 31 is disconnected from the main board. When all of the under test disk drives 31 are in connection with the main board, the RAID unit 11 is fully built. When any one of the under test disk drives 31 is disconnected from the main board, the RAID unit 11 is degraded.

The control unit 15 receives the first status signals and the second status signal from the state recognition unit 13, records the first status signals and the second status signal therein, and controls the reliability test of the RAID unit 11 to halt or continue according to the first status signals and the second status signal. More specifically, if the under test disk drives 31 and the reserve disk drive 32 are all ready for rebuilding the RAID unit 11, the control unit 15 outputs a start signal to continue the reliability test. If any one of the under test disk drives 31 and the reserve disk drive 32 is not fit for rebuilding the RAID unit 11, the control unit 15 outputs an interrupt signal to halt the reliability test, and subsequently receives new first and second status signals from the state recognition unit 13 until the reliability test can be continued. In this embodiment, the RAID unit 11 starts to rebuild only when any one of the under test disk drives 31 is disconnected from the main board, and the reserve disk drive 32 successfully begins to work as a replacement of the disconnected under test disk drive 31 under control of the control unit 15.

The control unit 15 also converts the first and second status signals received from the state recognition unit 13 to alphabetic characters which can be read directly by a user, and then outputs the alphabetic characters to the display unit 16. The display unit 16 includes an LED display screen. The display unit 16 is electrically connected with the control unit 15 for displaying the alphabetic characters, thereby showing the user the working states of the under test disk drives 31 and the reserve disk drive 32. Therefore, the working states of the under test disk drives 31 and the reserve disk drive 32 during the whole reliability test are easily viewed by the user. Furthermore, the control unit 15 records a period of time taken by the reliability test and a period of time taken rebuilding the RAID unit 11, and outputs the results to the display unit 16 for displaying to the user.

An electric power port 29 is provided at a corner of the back surface of the testing device 10. The electric power port 29 electrically connects to an external power source for obtaining electric power from the power source.

During the reliability test of the RAID unit 11, one of the control buttons 23 is pressed to the second position, such that the corresponding under test disk drive 31 is disconnected from the main board. That is, the corresponding under test disk drive 31 is removed from operation in the RAID unit 11. Thus, the RAID unit 11 is degraded. The state recognition unit 13 detects the working state of the disconnected under test disk drive 31, and sends a corresponding first status signal to the control unit 15. The control unit 15 receives the first status signal, and then controls the reserve disk drive 32 to begin to work as a replacement for the disconnected under test disk drive 31. The state recognition unit 13 detects the working state of the reserve disk drive 32 to determine if the reserve disk drive 32 successfully begins to works as a replacement for the disconnected under test disk drive 31, and if the determination is yes, the state recognition unit 13 then controls the RAID unit 11 to start to rebuild the lost data automatically.

In summary, the state recognition unit 13 can automatically identify the working states of the under test disk drives 31. The status information of the under test disk drives 31 is transmitted by the state recognition unit 13 to the control unit 15 when one of the under test disk drives 31 is disconnected. Thereupon the control unit 15 controls the reserve disk drive 32 to begin to work as a replacement for the disconnected under test disk drive 31 automatically. When the reserve disk drive 32 successfully works as a replacement of the disconnected under test disk drive 31, the status information of the reserve disk drive 32 is transmitted by the state recognition unit 13 to the control unit 15 automatically, which greatly simplifies the RAID reliability testing. Furthermore, the display unit 16 displays the test results in real time during the reliability testing. Therefore the reliability test provides easy visual monitoring by a user, who can readily and accurately determine whether the reliability test has succeeded or failed.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. A testing device for a Redundant Array of Independent Disks (RAID) unit comprising a plurality of under test disk drives, the testing device comprising:
a replacing unit comprising at least one reserve disk drive;
a state recognition unit configured for detecting working states of the under test disk drives and the reserve disk drive, respectively, and outputting a plurality of status signals corresponding to the working states of the under test disk drives and the reserve disk drive, respectively;
a switching unit comprising a plurality of buttons corresponding to the under test disk drives, respectively, each of the buttons being configured to switch between a first position in which a corresponding under test disk drive is in connection with the RAID unit and a second position in which the corresponding under test disk drive is disconnected from the RAID unit;
a control unit configured for receiving the status signals from the state recognition unit and controlling the at least one reserve disk drive of the replacing unit to begin to work as a replacement of the disconnected under test disk drive for rebuilding the RAID unit; and
a display unit configured for displaying a testing result thereon.

2. The testing device of claim 1, wherein each of the under test disk drives is configured to be inserted into a corresponding one of a plurality of main slots of the RAID unit.

3. The testing device of claim 2, wherein the RAID unit further comprises a main circuit board therein, a plurality of data interfaces aligned with the main slots, respectively, and a signal interface, the data interfaces and the signal interface being electrically connected to the main board.

4. The testing device of claim 1, further comprising an electric power port for electrically connecting to an external power source, wherein the switching unit further comprises another button aligned with the electric power port, and the another button can be switched between a first position whereby the testing device is turned on and a second position whereby the testing device is turned off.

5. The testing device of claim 4, wherein the electric power port and the another button are located at two opposite sides of the testing device.

6. The testing device of claim 1, wherein the state recognition unit further comprises a plurality of indicator lights corresponding to the under test disk drives and the at least one reserve disk drive, respectively.

7. The testing device of claim 1, wherein the display unit comprises an LED display screen.

8. The testing device of claim 1, wherein the control unit is further configured to convert the status signals to alphabetic characters and output the alphabetic characters to the display unit for displaying thereon.

9. The testing device of claim 8, wherein the control unit is further configured to record a period of time taken rebuilding the RAID unit, and output the result to the display unit for displaying thereon.

10. The testing device of claim 1, wherein the testing result comprises one of the replacing unit successfully beginning to work as a replacement of the disconnected under test disk drive and the replacing unit not successfully beginning to work as a replacement of the disconnected under test disk drive.

11. A testing device for a Redundant Array of Independent Disks (RAID) unit comprising a plurality of under test disk drives, the testing device comprising:
a replacing unit comprising a reserve disk drive;
a switching unit comprising a plurality of buttons corresponding to the under test disk drives, respectively, each of the buttons being configured to switch between a first position in which a corresponding under test disk drive is in connection with the RAID unit and a second position in which the corresponding under test disk drive is disconnected from the RAID unit;
a state recognition unit configured for outputting a plurality of status signals corresponding to the under test disk drives, respectively;
a control unit configured for receiving the status signals from the state recognition unit and controlling the reserve disk drive of the replacing unit to begin to work as a replacement of the disconnected under test disk drive for rebuilding the RAID unit; and
a display unit configured for displaying a testing result thereon.

12. The testing device of claim 11, wherein each of the under test disk drives is configured to be inserted into a corresponding one of a plurality of main slots of the RAID unit.

13. The testing device of claim 12, wherein the RAID unit further comprises a main circuit board therein, plurality of data interfaces aligned with the main slots, respectively, and the data interfaces are electrically connected to the main circuit board.

14. The testing device of claim 11, further comprising an electric power port for electrically connecting an external power source, wherein the switching unit further comprises another button aligned with the external power source, and the another button can be switched between a first position whereby the testing device is turned on and a second position whereby the testing device is turned off.

15. The testing device of claim 14, wherein the electric power port and the another button are located at two opposite sides of the testing device.

16. The testing device of claim 11, wherein the state recognition unit further comprises a plurality of indicator lights corresponding to the under test disk drives and the reserve disk drive, respectively.

17. The testing device of claim 11, wherein the display unit comprises an LED display screen.

18. The testing device of claim 11, wherein the control unit is further configured to convert the status signals to alphabetic characters and output the alphabetic characters to the display unit for displaying thereon.

19. The testing device of claim 18, wherein the control unit is further configured to record a period of time taken rebuilding of the RAID unit, and output the result to the display unit for displaying thereon.

20. The testing device of claim 11, wherein the testing result comprises one of the replacing unit successfully beginning to work as a replacement of the disconnected under test disk drive and the replacing unit not successfully beginning to work as a replacement of the disconnected under test disk drive.
